(19) United States
(12) Patent Application Publication
(10) Pub. No.: US 2022/0048803 A1
(43) Pub. Date: Feb. 17, 2022

(54) SYSTEMS AND METHODS FOR MOLDING CHALCOGENIDE GLASS INTO A NEAR-NET SHAPED PART

(71) Applicant: LightPath Technologies, Inc., Orlando, FL (US)

(72) Inventors: Dennis Knowles, Oviedo, FL (US); Joseph Leite, St. Cloud, FL (US); Spencer Novak, Winter Springs, FL (US)

(21) Appl. No.: 17/163,046

(22) Filed: Jan. 29, 2021

Related U.S. Application Data
(60) Provisional application No. 63/065,179, filed on Aug. 13, 2020.

(51) Int. Cl. C03B 11/05; C03C 19/00

(52) U.S. Cl. CPC C03B 11/05; C03C 19/00

(57) ABSTRACT

A method of fabricating a shaped optical element for refracting infrared light. The method can include providing a chalcogenide glass mass within a precision mold, the chalcogenide glass mass having a starting volume that is equal to or less than about 105% of the volume of the shaped optical element, precision molding the chalcogenide glass mass by providing heat and pressure to form the chalcogenide glass mass into a near-net shaped optical element, removing the near-net shaped optical element from the precision mold, and refining the near-net shaped optical element to generate the shaped optical element, the outside diameter of the near-net shaped optical element being less than or equal to 25 μm larger than an outside diameter of the shaped optical element. The near-net shaped optical element can have an outside diameter less than 20 μm greater than the outside diameter of the shaped optical element.

### INCORPORATION BY REFERENCE TO ANY PRIORITY APPLICATIONS

This application claims the benefit of priority of U.S. Provisional Application No. 63/065,179 titled “Systems and Methods for Molding Chalcogenide Glass into a Near-net Part” (Docket No. LPATH.006PR), which was filed on Aug. 13, 2020, the entire disclosure of which is expressly incorporated herein by reference.

### BACKGROUND OF THE INVENTION

### Field

The present disclosure relates to fabrication of precision optical elements, including but not limited to precision optical elements for use in the infrared (IR) spectrum of electromagnetic radiation.

### Description of the Related Art

Traditional materials used for infrared optics include salts and crystals such as germanium (Ge) or zinc selenide (ZnSe). These materials can involve expensive processing techniques and the materials themselves also have a high cost. In many cases, the fabrication of an optical element, such as a lens, begins with a blank of raw material (usually a disc) which is polished into the desired shape to form the optical element. A large portion of material, however, is ultimately removed during polishing and not used. This is because the blank is at least as large as the final optical element in every dimension, making it significantly greater in volume than the finished optic, especially for thin optics with large sagittal depths and/or heights. The growing demand for thermal imaging sensors and cameras supports means producing large volumes of lower cost optics in the infrared region can be desirable.

Chalcogenide glass transmits primarily in the midwave-infrared (MWIR) and longwave-infrared (LWIR) wavebands, making it suitable for thermal imaging applications. As with any manufacturing process, ways to increase or maximize the use of raw materials and reduce the cost of chalcogenide optics can be desirable. Chalcogenide glass can be molded (heated and formed into a shape under pressure) and thus the resulting optical element may have less wasted material than traditional optical lens making processes.

### SUMMARY

Aspheric and diffractive surfaces on optical elements comprising infrared materials are traditionally fabricated by single point diamond turning, which is generally a high-cost, low-throughput process, that can be unsuitable for low-cost, high-volume applications. Various methods of manufacturing optical elements disclosed in herein, however, relates to precision molding of chalcogenide glasses that allow the efficient fabrication of quality infrared optics in large volumes.

Various implementations of methods and apparatus within the scope of the appended claims each have several aspects, no single one of which is solely responsible for the desirable attributes herein. Without limiting the scope of the appended claims, some prominent features are described herein.

One innovation includes a method of fabricating a shaped optical element for refracting infrared light, the method comprising providing a chalcogenide glass mass within a precision mold, the chalcogenide glass mass having a starting volume that is equal to or less than about 105% of the volume of the shaped optical element, precision molding the chalcogenide glass mass by providing heat and pressure to form the chalcogenide glass mass into a near-net shaped optical element, removing the near-net shaped optical element from the precision mold, and refining the near-net shaped optical element to generate the shaped optical element, the outside diameter of the near-net shaped optical element being less than or equal to 25 μm larger than an outside diameter of the shaped optical element.

Various embodiments of such methods can include more or other features, some of which are listed below. In some embodiments, refining the near-net shaped element comprises diamond turning the near-net shaped optical element to form the shaped optical element. In some embodiments, refining the near-net shaped element comprises grinding and/or polishing the near-net shaped optical element to form the shaped optical element. In some embodiments, refining the near-net shaped element comprises removing unwanted chalcogenide glass from the near-net shaped optical element, wherein the glass material removed from the near-net shaped optical element is no more than 0.01-3% of the volume of the shaped optical element. In some embodiments, the starting volume of the chalcogenide glass mass is equal to or less than 101-104% of the shaped optical element. In some embodiments, the near-net shaped optical element removed from the precision mold has an outside diameter that is no more than 10-20 μm greater than the outside diameter of the shaped optical element. In some embodiments, the outside diameter of the near-net shaped optical element removed from the precision mold is less than 10 μm greater than the outside diameter of the shaped optical element. In some embodiments, precision molding the chalcogenide glass mass comprises performing the precision molding in a sealed chamber with controlled atmosphere. In some embodiments, the atmosphere is controlled to be an inert gas, the air, or in vacuum. In some embodiments, the inert gas comprises nitrogen or argon. The chalcogenide glass mass can have certain characteristics. In some embodiments, the chalcogenide glass mass is polished or unpolished. For example, in some embodiments, the chalcogenide glass mass has a geometry of a ball, disc, gob, rod, or rectangular solid. In some embodiments, the chalcogenide glass mass has a geometry of a ball having a predetermined surface quality and a predetermined roundness.

In some embodiments, the method further includes aligning portions of the mold using an alignment sleeve. In some embodiments, the method further includes aligning portions of the mold by adjusting a stage position and a tilt position to align portions of the mold. In some embodiments, the method further includes coating the shaped optical element with a lens coating. In some embodiments, the method further includes coating the shaped optical element with an anti-reflective coating. In some embodiments, the method further includes coating the shaped optical element with a coating which blocks predetermined wavebands of light. In some embodiments, the method further includes coating the shaped optical element with a coating which provides abrasion resistance.

### BRIEF DESCRIPTION OF THE DRAWINGS

FIGS. 1A-C illustrate an example of pre-generation molding using a sleeve to align the molds. FIG. 1A is a diagram of tooling prior to molding; FIG. 1B illustrates compression of material between molds; and FIG. 1C illustrates removal of pre-generation from tooling.

FIGS. 2A-C illustrate another example of pre-generation molding using stage adjustment to align molds. FIG. 2A is a diagram of tooling prior to molding; FIG. 2B illustrates compression of material between molds; and FIG. 2C illustrates removal of pre-generation from tooling.

FIGS. 3A-B illustrate examples of how pre-generation can be shaped into an optical element. FIG. 3A illustrates a method using single point diamond turning; and FIG. 3B illustrates a method using grinding and/or polishing processes.

FIG. 4 is a process flow diagram illustrating an example method of fabricating a shaped optical element for refracting infrared light.

### DETAILED DESCRIPTION OF CERTAIN INVENTIVE ASPECTS

Using aspheric surfaces and diffractive optical elements (DOE) in a lens design can significantly reduce the number of elements possibly without trading off performance. In IR optics, aspheric and diffractive surfaces can be fabricated by single point diamond turning (SPDT), as most materials used in IR are relatively soft. However, optical fabrication by SPDT is an expensive, low-throughput process, and thus may not be suitable for high volume commercial applications, where low cost is a critical factor. The present disclosure relates to the precision molding of chalcogenide glass (ChG) as a process to reduce cost and increase throughput in high volume IR imaging applications. ChGs are particularly suitable for the molding technology, as they are moldable at low temperatures. ChGs also transmit the IR radiation very well, and have excellent thermal properties compared to other IR materials.

Various embodiments disclosed in the present application are directed to systems and methods of precision molding ChG into a near-net shape before being subjected to a finishing process to complete the shaping of an optical element. Sufficient precision in the molding process allows for shorter finishing steps, and removing far less material from a molded optical element to form a shaped optical element. The optical element may be designed for imaging, collimating, or other optical applications operating at IR wavelengths. The optical element may comprise a lens having one or more spherical, aspheric, diffractive, and/or planar surfaces. Such surfaces may have optical power. The optical element may be a lens that is substantially optically transmissive or transparent to infrared (IR) light. The optical element may be a component associated with a telescope, a laser, laser system and imaging sensor/system or other type of optical system and may include a detector, fiber, sensor and/or other optical component(s).

In an example method, a lens may be precision molded to form an optical element having a near-net final shape and volume, and have a single finishing process (e.g., diamond turning) to form its final shape and final volume. This can include providing a chalcogenide glass mass within a precision mold, the chalcogenide glass mass having a starting volume that is equal to or less than about 105% of the final volume of the finished shaped optical element, precision molding the chalcogenide glass mass to form a near-net shaped optical element, removing the near-net shaped optical element from the precision mold, and refining the near-net shaped optical element to generate the finished shaped optical element, wherein the near-net shaped optical element has an outside diameter (OD) that is larger than an OD of the finished shaped optical element by less than, for example, 25 μm, and possibly equal to the OD of the finished shaped optical element. In some embodiments, the volume of the starting chalcogenide material is only to be slightly greater in volume than the final shaped optical element (e.g., ˜3%). In some embodiments, the precision mold used in the precision molding method has interior dimensions that are very close to the desired final shaped optical element. For example, the precision mold forms an outside diameter of the optical element that is within about 25 μm of the desired shaped optical element. In the hot forming process of chalcogenide glass during molding, atmosphere can be important. Therefore, in some embodiments, the precision molding of the chalcogenide glass may take place in a sealed chamber with atmosphere control capability. In some embodiments, precise molding is enabled by precise alignment of the molds and/or highly accurate mold surface prescriptions. Alignment of the molds can be done using a sleeve, or by adjustment of stage position and tilt to orient the molds.

In some embodiments, during molding, a starting chalcogenide glass material is placed in the precision mold. The starting chalcogenide material may be a ball, disc, gob, or other suitable geometry of glass. The starting material is less than or equal to 103% of the volume of an optical element being formed. The chalcogenide material is then heated to a point that it exhibits viscous flow, and then compressed in the precision mold and cooled to form a near-net shape of the desired optical element. In some embodiments, the glass is heated above its glass transition temperature (T_{g}) during the precision glass molding (PGM) process, so the thermal history of the glass is altered and can therefore change the glass properties. Molding process of chalcogenide glass into a near-net shape may be dependent on the physical properties of the starting chalcogenide material of the IR optical element. For example, the temperature, heating rate, pressure, and atmospheric conditions during molding may be specifically selected based on the material composition of the chalcogenide glass, and/or vice versa, in order to produce the precision molding. The dimensions of precision molded optical element are very close to the final dimensions of the desired optical element (e.g., within 3% by volume of the desired optical element, or by having an OD within about 25 μm of the OD of the desired optical element).

In some embodiments, the starting volume of the chalcogenide glass mass is equal to or less than 100.5%, 101%, 102%, 103%, 104%, 105%, 106%, 107%, 108%, 109%, 110%, 111%, 112%, 113%, 114%, 115%, 116%, 117%, 118%, 119%, 120%, 121%, 122%, 123%, 124%, 125%, 126%, 127%, 128%, 129%, or 130% (+/−0.5%) of the final shaped optical element or may be in a range formed by any two of these values. For example, in some embodiments, the starting volume of the chalcogenide glass mass is equal to or between about 100.5% and 101%, between 100.5% and 102%, between 101% and 104%, between 102% and 105%, between 104% and 110%, between 105% and 120%, or between 110% and 130% of the shaped optical element. In some embodiments, the near-net shaped optical element has an outside diameter that is within 0.5 μm, 1.0 μm, 1.5 μm, 2.0 μm, 2.5 μm, 3.0 μm, 4.0 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, or 30 μm (+/−0.5 μm) of the outside diameter of the final shaped optical element or may be in a range formed by any two of these values or may include any of these values. For example in some embodiments, the near-net shaped optical element has an outside diameter that is within 0.5 to 5 μm, 2.5 to 10 μm, 5 to 15 μm, 10 to 20 μm, 15 to 25 μm, or 20 to 30 μm of the outside diameter of the shaped optical element.

After the precision molded optical element is cooled, the optical element is removed from the mold and further shaped (refined), e.g., by removing unwanted chalcogenide glass from the near-net shaped optical element to form the finished or final shaped optical product (e.g., lens). The refining step may be performed by single point diamond turning, or grinding and polishing. In some embodiments, during the refining step, the glass material removed from the near-net shaped optical element is less than 3% of the volume of the final shaped optical element. In some embodiments, during the refining step, the glass material removed from the near-net shaped optical element is less than or equal to 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, or 5.0% of the volume of the final shaped optical element or may be in a range formed by any two of these values. In some embodiments, during the refining step, the glass material removed from the near-net shaped optical element is less than or equal to 5%, 6%, 7%, 8%, 9%, 10%, 11%, 12%, 13%, 14%, 15% or 20% of the volume of the shaped optical element or may be in a range formed by any two of these values or may include any of these values. For example, in some embodiments, during the refining step, the glass material removed from the near-net shaped optical element is from 0.5% to 1%, from 0.5% to 2%, from 1% to 4%, from 2% to 5%, from 4% to 10%, from 5% to 20%, or from 10% to 30% of the volume of the shaped optical element.

In some embodiments, the finished optical element may be or may be used in: passive optical components, lenses, optical modules, multi-channel optical modules, optoelectronic modules, multi-channel optoelectronic modules, optical devices, multi-channel optical devices, wafers, wafer stacks, photographic equipment, communication devices, smartphones, sensors, proximity sensors, ambient light sensors, cameras, telescopes, microscopes, range finders or other components, devices, or systems.

One non-limiting advantage of the precision molding process is that this process allows for a smaller starting volume of material, because the starting material (called a preform in this process) only needs to be slightly greater in volume than the final shaped optic. Another non-limiting advantage is that the flexibility in the preform geometry allows for further increases in the efficiency of the process, because the preform geometry can be configured or optimized to the geometry of the raw material. For instance, in various implementations, the preform geometry is chosen such that it packs efficiently into the dimensions of the raw material, unlike in various conventional methods where a given lens design would have a unique blank geometry that may or may not be able to be efficiently fabricated. For example, the raw material glass may be made in fixed-diameter cylindrically shaped boules that are sliced into large discs. The preforms may be smaller discs that are cored from an individual large disc. The outside diameter of the preform may be selected that can pack efficiently into the large disc diameter, and the thickness of the slice may be adjusted to get the desired preform volume. Yet another non-limiting advantage of increasing or maximizing the use of raw material is reducing the wasted material and thus the cost of an optic. Yet another non-limiting advantage of the precision molding process is that this process allows for shorter finishing steps (e.g., diamond turning). Yet another non-limiting advantage of various methods of manufacture disclosed herein is that molding chalcogenide glass into a near-net shape before being subjected to finishing steps may be less expensive and/or a simpler manufacturing method as compared to other methods. In some cases, the number of steps or amount of time for manufacturing may be reduced, which decreases the overall costs. In various embodiments, the finished optical element may then be tested to determine whether it performs within the desired tolerances. Reducing the number and complexity of the steps for manufacturing the optical element may result in an increase in yield. Yet another non-limiting advantage of the manufacturing process is that precision glass molding (PGM) enables high-performance, low-cost lens designs through aspheric shapes and a broad array of moldable glass types. For example, PGM offers increased efficiency because the molding cycle is much shorter than the process of grinding and polishing or diamond turning a lens. Production costs are also decreased because the molds can be reused for pressing many lenses. Yet another non-limiting advantage of using chalcogenide glass, over using, for example, pure germanium, is that it is significantly cheaper by mass, and that it can be formed to shape by applying heat and pressure without crystallizing the material.

Reference will now be made to the figures, in which like reference numerals refer to like parts throughout.

### Example Precision Mold

Molds for precision glass molding (PGM) may be manufactured using precision diamond turning or precision diamond grinding to generate the optical surface. The molded component replicates the surface of the mold, and therefore any defects on the molds will be replicated on the component itself. High precision in the mold dimensions results in forming a near-net shaped optical element that needs a small or sufficiently reduced amount of diamond-turning to form the final shaped optical product. The cavity formed by the mold may be slightly larger (e.g., within 105%) of the volume of the near-net shaped lens. The use of smaller molds, i.e., molds that form inner cavities that are closer (e.g., within 105%) to the volume of the near-net shaped lens may increase precision and reduce waste in the subsequent diamond-turning. Carbide or ceramic tooling may be used in PGM because of the high temperatures involved during processing. Carbide or ceramic molds may be manufactured by precision diamond grinding. In some embodiments, tungsten carbide molds may be used for molding aspheric, spherical, and plano optical surfaces, and is especially advantageous for low-cost, high volume manufacturing.

In some embodiments, tungsten carbide (WC) may be used as a mold material for PGM. In alternative embodiments, other mold materials including but not limited to nickel, SiC, and graphite, with coatings including but not limited to PtIr, may be used as a mold material for PGM.

### Example Glass Composition

Although there are many plastic materials to choose from for the visible spectrum, these polymers generally absorb longwave infrared light, and are therefore generally inadequate for thermal applications operating in the LWIR (8-12 μm) band. Although crystalline materials such as Ge, ZnS, and ZnSe transmit well in the LWIR band, they are generally not moldable and therefore they are not well-suited to high-volume, low-cost production.

In some embodiments, chalcogenide materials may be used for LWIR lens applications. The moldability of chalcogenide glass qualifies it for the high-volume demand of commercial longwave IR applications. Although precision glass molding (PGM) of chalcogenides may be used to manufacture low cost optics in the longwave infrared, some of the most commonly used chalcogenides in PGM to date have been compositions containing germanium, such as Ge28Sb12Se60 and Ge22As20Se58. Another germanium-free composition is As40Se60.

Chalcogenide glasses (ChGs) are binary or ternary systems containing at least one element from the chalcogen series, specifically sulfur, selenium, and tellurium, with the exception of oxygen. Typically, ChGs have low glass transition temperatures due to the weak bonding effected by the large atomic radii of those elements combined with low covalent coordination (8-n rule) associated with the chalcogen elements. Most commercial ChGs used in IR optics are ternary systems that also contain Germanium (Ge). Ge is added to the composition to increase the glass transition temperature and durability, making them useful across a wider range of applications and environments. ChGs transmit well in both 3-5 μm and 8-12 μm IR spectral regions, and maintain good transmission up to 120° C. and even higher, unlike Ge, which becomes opaque above 80° C.

One or more of the chalcogens can be paired with at least germanium (Ge) or arsenic (As) for chemical stability. Other elements such as antimony (Sb) may be added to the composition to achieve desired properties. These glasses transmit primarily in the midwave-infrared (MWIR) and longwave-infrared (LWIR) wavebands, making them suitable for thermal imaging applications. As opposed to traditional crystalline lens materials for LWIR, such as Ge, ZnS, ZnSe, the moldability of chalcogenide glass qualifies it for the high volume demand of commercial applications. The transmission window of sulfide glasses only extends to about 11 μm, limiting it to MWIR applications. Some example chalcogenide glass compositions can be found in Table 1.

TABLE 1
Example chalcogenide glasses

| Glass Composition | Transmission Waveband | Notes |
|---|---|---|
| Ge₃₃As₁₂Se₅₅ | Suitable for LWIR | |
| Ge₃₀As₁₃Se₃₂Te₂₅ | Suitable for LWIR | |
| Ge₁₀As₄₀Se₅₀ | Suitable for LWIR | |
| Ge₂₈Sb₁₂Se₆₀ | Suitable for LWIR | Arsenic-Free |
| As₄₀Se₆₀ | Suitable for LWIR | Germanium-Free |
| As₄₀S₆₀ | MWIR only | |
| Ge₂₂As₂₀Se₅₈ | Suitable for LWIR | |

### Example Molding Process

Precision glass molding is a compression molding process (as opposed to, for example, injection molding) capable of transferring high-quality aspheric shapes from a precision mold set into the optical lens being formed. This technology has the distinct advantage of enabling low cost optical lenses for high volume applications, while maintaining the high quality of aspheric optical surface profiles and utilizing the inherent advantages of glass materials.

Precision glass molding, PGM, is a manufacturing process used to make high quality lenses and optical components. The general nature of the process is the compression molding of glass preforms at high temperature under highly controlled conditions. A brief summary of the PGM process follows. The PGM process starts with the manufacturing of tooling designed specifically for the product to be manufactured. This tooling can include, for example, a top mold, a bottom mold and ancillary tooling to form the outside diameter (OD) or other features of the component. Additional tooling may be used to align the individual mold halves. The customized tooling is then inserted into the glass molding machine. A glass preform is then inserted into the tooling stack. The top mold is then introduced and the system is evacuated. The tooling stack and the glass preform are then heated at a controlled rate. The final processing temperature is dependent on the individual glass type. The preform is then put under compression in order to begin forming the glass. The amount of load applied to the glass is controlled throughout the molding cycle; the load is removed when the cycle is completed. The tooling stack is then cooled, for example, by purging the system with an inert gas. In order to cost effectively manufacture the lens, this cooling cycle may be configured to increase cooling rate and accomplish the fastest possible cycle time. Once the product is cool enough to handle, the component is removed and the process is repeated.

Precision glass molding is used to make a variety of components including aspheric lenses, lens arrays, cylindrical lenses, spherical optics and even V-groove blocks used for fiber optic assemblies. A precision glass molded aspheric lens can have a number of standard lens shapes and sizes. PGM lenses can be bi-convex (BCX), plano-convex (PCX), meniscus (MEN), plano-concave (PCV) and even bi-concave (BCV) lenses. Outside diameters may range from sub-millimeter to over 100 mm, such as within the 1-25 mm range or in the 25 to 50 range or in the 50 to 75 mm range or in the 75 to 100 mm range or in any combination of these or possibly larger or smaller.

The proper selection of the right moldable optical glass can increase performance, decrease lead times and significantly improve cost. Lower processing temperatures in PGM can mean shorter cycle times due to shortened heating and cooling cycles. Shorter cycles improve processing speeds, increasing throughput. A lower temperature process results in less energy use and cheaper utility expenses. Lower processing temperatures also reduce the potential for oxidation of surfaces during the molding process. Oxidation leads to contamination, increasing the frequency of cleaning and maintenance. While the PGM process may not be explicitly performed at the glass transition temperature, T_{g}, of the specific glass, it can be an excellent indicator of the relative processing temperature. Therefore, T_{g} can be used as a quick indicator of potential moldability and relative processing cost.

In some example PGM processes, the molding temperature may be chosen based on T_{g}, e.g., to scale with glass T_{g}. The actual molding temperature may vary with lens geometry as well. In some example PGM processes, the amount of force applied to the molds may depend on factors such as lens geometry, actual molding temperature, tooling clearance, etc. In some example PGM processes, inert atmosphere may be optionally used.

### Example Molding Using Sleeve

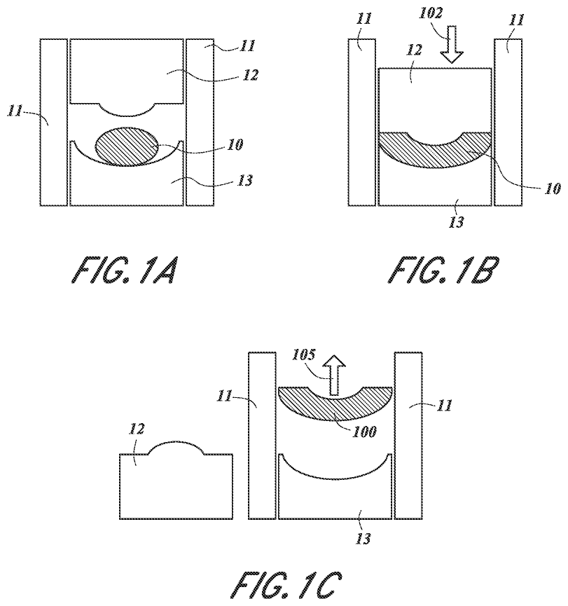

FIGS. 1A-1C shows a simplified schematic cross-section of the press molding operation. The pressing apparatus includes two molds 12 and 13 that have been fabricated with the desired surfaces. The molds are placed into a sleeve 11 with an optical material (ChG preform) 10. FIG. 1A is a diagram of tooling using the alignment sleeve 11 to align an upper mold (top mold) 12 and a lower mold (bottom mold) 13 for pre-generation molding of an optical material 10.

FIG. 1B illustrates compression 102 of the optical material 10 between the upper mold 12 and lower mold 13. Both heat and pressure are applied to the system to mold the chalcogenide glass preform into the desired shape. Precise tooling design and fabrication as well as precise process control are critical to the successful molding of high quality optics.

When the molding process is completed, FIG. 1C illustrates removal 105 of pre-generation 100 from the tooling.

### Example Fabrication Tolerances for Optics Molded Using Sleeve

The sensitivity of an optical system to the fabrication and assembly errors depends primarily on the F/#, wavelength, and design. In general, faster lenses (lower F/#) and systems operating at shorter wavelengths may be more sensitive to these errors. Also, designs with relatively large refraction angles at an optical surface are generally sensitive to the errors on that particular surface. In IR, the operation wavelength is long, so IR lenses are relatively less sensitive to fabrication errors compared to lenses in the visible wavelength range. However, many commercial thermal imaging applications use very fast lenses (F/1.4 down to F/0.8) in order to gather as much light as possible onto the uncooled microbolometer FPA. The small F/# makes these lenses very sensitive to fabrication and assembly errors.

Establishing tolerances for the fabrication and assembly errors can be a useful step in the lens design, as tolerances can significantly affect the modulation transfer function (MTF) and also determine the manufacturability, assembly method, and cost of the optics. Some possible optical fabrication errors are power/irregularity, glass center thickness (CT), surface tilt, surface decenter, and the refractive index. Some possible optical assembly errors are air CT, element tilt, and element centration. Tighter tolerances can increase the cost of the optics, so the tolerances may be loosened while possibly still satisfying the performance requirements of the application a close proximity thereto with a reasonable yield. A tolerance sensitivity analysis can determine which errors have the most significant impact on the MTF. A Monte Carlo tolerance analysis can be run to estimate the yield and the worst-case MTF.

The disclosed precision molding process using sleeve allows the high-volume fabrication of IR optics with tight tolerances of the surface profile. Aspheric optics with surface power/irregularity of less than 3/1 fringes (at 633 nm) or even tighter can be fabricated in high volumes up to 35 mm in diameter. In some implementations, therefore, the surface power tolerance can be from 1 to 6 fringes, or 1-5 fringes, or 1-4 fringes, or 2-6 fringes, or 2-5 fringes, or 2-4 fringes, or any combination thereof of other range formed by any combination of end values listed here. Similarly, in some implementations the surface power tolerance may be from 0.5 to 12 waves, or 0.5-10 waves, or 0.5-8 waves, or 0.5-6 waves, or 0.5-4 waves, or 0.5-3 waves, or 0.5-2 waves, or 0.5-1 waves, or 1-12 waves, or 1-10 waves, or 1-8 waves, or 1-6 waves, or 1-4 waves, or 1-3 waves, or 1-2 waves, 2-12 waves, 2-10 waves, or 2-8 waves, or 2-6 waves, or 2-4 waves, or 2-3 waves, or any combination thereof of other range formed by any combination of end values listed here. Is some implementations, the irregularity tolerance can be from 0.2 to 2 fringes, or 0.4-2 fringes, or 0.5-2 fringes, or 0.6-2 fringes, or 0.8-2 fringes, or 0.2-1.8 fringes, or 0.4-1.8 fringes, or 0.5-1.8 fringes, or 0.6-1.8 fringes, or 0.8-1.8 fringes, or 0.2-1.6 fringes, or 0.4-1.6 fringes, or 0.5-1.6 fringes, or 0.6-1.6 fringes, or 0.8-1.6 fringes, or 0.2-1.5 fringes or 0.4-1.5 fringes, or 0.5-1.5 fringes, or 0.6-1.5 fringes, or 0.8-1.5 fringes, or 0.2-1.4 fringes, or 0.4-1.4 fringes, or 0.5-1.4 fringes, or 0.6-1.4 fringes, or 0.8-1.4 fringes, or 0.2-1.2 fringes, or 0.4-1.2 fringes, or 0.5-1.2 fringes, or 0.6-1.2 fringes, or 0.8-1.2 fringes, or any combination thereof of other range formed by any combination of end values listed here. Similarly, in some implementations the surface power tolerance may be from 0.1 to 4 waves, or 0.1-3 waves, or 0.1-2 waves, or 0.1-1 waves, or 0.1-1.8 waves, or 0.2-1.8 waves, or 0.1-1.8 waves, or 0.4-1.8 waves, or 0.5-1.8 waves, or 0.6-1.8 waves, or 0.8-1.8 waves, or 0.2-1.6 waves, or 0.4-1.6 waves, or 0.5-1.6 waves, or 0.6-1.6 waves, or 0.8-1.6 waves, or 0.2-1.5 waves, or 0.4-1.5 waves, or 0.5-1.5 waves, or 0.6-1.5 waves, or 0.8-1.5 waves, or 0.2-1.4 waves, or 0.4-1.4 waves, or 0.5-1.4 waves, or 0.6-1.4 waves, or 0.8-1.4 waves, or 0.2-1.2 waves, or 0.4-1.2 waves, or 0.5-1.2 waves, or 0.6-1.2 waves, or 0.8-1.2 waves, or any combination thereof or other range formed by any combination of end values listed here. As used herein, a fringe refers to half a wavelength, i.e., ½ wave. In some embodiments, the process can be expanded to manufacture up to 50 mm, 40 mm, 30 mm, 20 mm, diameter optics or can be smaller such as down to 10 mm or 1 mm or sizes in a range formed by any of these values and may include any of these values. Larger and small sizes may also be possible.

### Example Molding Using Stage Adjustment

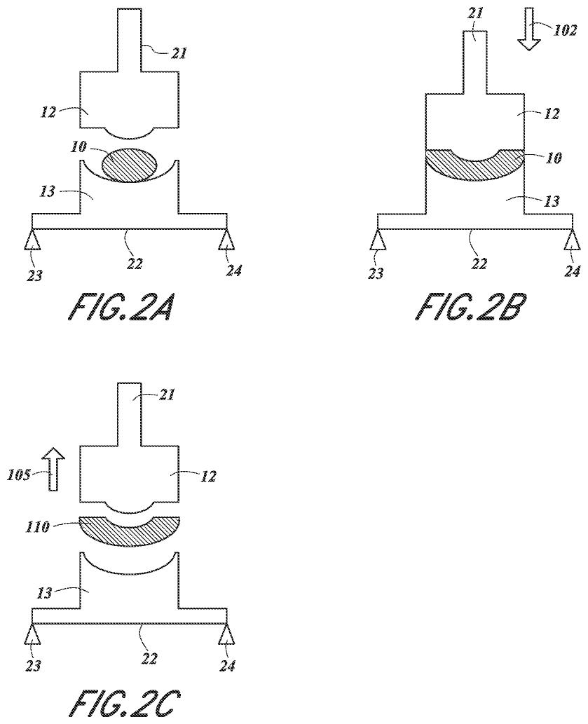

FIG. 2A-C shows another schematic cross-section of the press molding operation. The PGM process starts with the manufacturing of tooling designed specifically for the product to be manufactured. This tooling includes upper mold 12 and lower mold 13. Additional tooling may be used to align the individual mold halves. FIG. 2A is a diagram of tooling using adjustment knobs 21, 23, and 24 to adjust stage 22 position and tilt and align an upper mold 12 and a lower mold 13 for pre-generation molding of an optical material (e.g. a glass preform) 10.

The customized tooling is inserted into the glass molding machine. The optical material 10 is inserted into the tooling stack. The upper mold 12 is included and the system is evacuated. The tooling stack and the optical material 10 are heated at a controlled rate. The final processing temperature is dependent on the individual glass type. The preform is put under compression in order to begin forming the glass.

In some implementations the manufacturing of tooling designed specifically for the product to be manufactured is followed by the customized tooling being inserted into the glass molding machine. The optical material 10 may then be inserted into the tooling stack although in some implementations the optical material may be inserted into the tolling stack prior to the introduction of the tooling stack into the glass molding machine. The upper mold 12 may be introduce or re-introduced after addition of the optical material. The system may be subsequently evacuated. The tooling stack may be heated with the optical material 10 therein although the tooling stack may he heated prior in alternative implementations. The heating may begin after evacuation. However, in other implementations heating may start prior to evacuation or at least some evacuating. The preform may be put under compression after heating is commenced although other approaches are possible. The order of the steps may be different in different implementations. Additional steps may also be added to the process, and steps may possibly be removed or altered.

FIG. 2B illustrates compression 102 of the optical material 10 between the upper mold 12 and lower mold 13. The amount of load applied to the glass is controlled throughout the molding cycle. The load may be removed once the cycle is completed. The tooling stack may then be cooled, possibly by purging the system with an inert gas. In some implementations, in order to manufacture the lens cost effectively, this cooling cycle may be designed to be fast and possibly optimized for the fastest possible cycle time.

Once the final product is cool enough to handle, the component may be removed, and the process may be repeated. FIG. 2C illustrates removal 105 of pre-generation 100 from tooling. Once again, the order of the steps may be different in different implementations. Additional steps may also be added to the process, and steps may possibly be removed or altered.

### Example Finishing Methods

When refining the near-net shaped optical element to generate the final shaped optical element, excess material may be removed from the near-net shaped optical element may be machined e.g., by using a dicing saw, laser cutting, laser ablation, water jet cutting, mechanical milling, grinding, polishing, ion-beam milling, micromachining, microtoming, magnetorheological finishing, cutting using blades, punch cutting, milling, chemical etching, reactive-ion etching, or diamond turning in particular for optical element rotational symmetry, and a computer numerical control (CNC) machine may be used to increase the precision. Other approaches or combinations of approaches are possible.

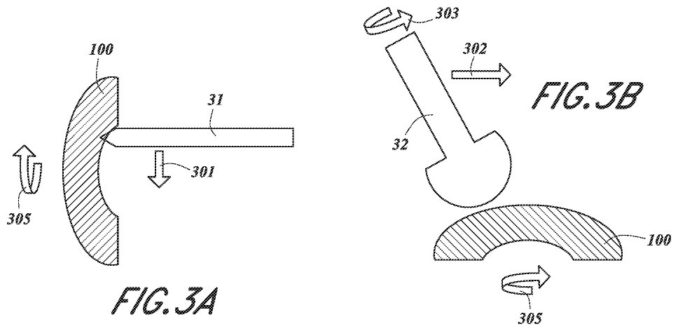

FIG. 3A illustrates a finishing method using single point diamond turning. The pre-generation 100 can be further shaped into an optical element via mechanical machining with a diamond-tipped tool bit 31. In some implementations, mechanical machining may include simultaneous rotation 305 of the pre-generation and translational motion 301 of the diamond-tipped tool bit with respect to the rotating pre-generation. Likewise, in some implementations, the pre-generation may be translated with respect to the diamond-tipped tool.

In some embodiments, a programmable computer controlled single point diamond turning (SPDT) lathe, can be used to generate the surfaces of the desired shaped optical element. For example, the lathe may have two moving subassemblies: a low vibration air bearing spindle, and x-z positioning slides. The near-net shaped optical element may be held and centered on the end of spindle. The near-net shaped optical element may be rotated by the spindle while a fine diamond tool (diamond-tipped tool bit) 31 is moved by the positioning slides possibly with sub-micron resolution both perpendicular to (i.e., tool transverse scan in x-direction) and parallel to (i.e., tool cutting depth in z-direction) the direction of the spindle's axis. In some case, smooth tool motion may be achieved by using hydrostatic oil-bearing or air-bearing slideways. Precise slide positioning may be achieved by using computer controlled piezoelectric drivers or precise lead screw drivers. Other approaches and variations are possible.

During various implementations of single point diamond turning, a computer receives synchronous signals from the spindle and controls the movement of the x-z translation slides along a programmed trajectory that is synchronized with the rotational position of the spindle. The motion of the x-translation slide (i.e. perpendicular to the spindle axis) may be at a uniform speed. However, forming a non-axially symmetric lens surface, when using a high speed lathe may involve a control method for positioning the z-translation slide (e.g., controls cutter movement parallel to the spindle axis and, consequently, the depth of cut on the lens surface which rotates rapidly with respect to the cutter). The z-translation slide may be rapidly and precisely located in accord with both the x-translation slide location, and possibly the rotational position of the spindle. Rapid and precise positioning of the z-translation slide may be achieved by the utilization of computer controlled piezoelectric drivers in some implementations. FIG. 3B illustrates a finishing method using grinding and/or polishing processes. The pre-generation 100 can be further shaped into an optical element, e.g., a lens, via mechanical machining with a polishing bonnet 32. Mechanical machining may include simultaneous rotation 305 of the pre-generation, translational motion 302, and rotation 303 of the polishing bonnet or any combination of these.

In some embodiments, the grinding process creates surface roughness on the surface of the lens, which tends to undesirably scatter light passing to or from the lens. To reduce this surface roughness, the lens may be further polished to obtain a smoother surface. In addition, polishing can provide a more precise curvature to the lens surface.

In some embodiments, automated grinding machines may have a cutter that is held stationary while rotating the lens and moving it along one or two axes with respect to the cutter. If the lens requires a curvature in addition to simple spherical and/or cylindrical cuts, the lens can, for example, be ground while tilted to produce an offset optical center in certain implementations. After the lens is ground, it may be sanded and/or polished.

In some embodiments, polishing machines may utilize a lap, which is an abrasive pad attached to a block having a reversed curvature of that of the lens. The lap and lens are rubbed together to remove the surface roughness left by the grinding process and possibly to make any final corrections to the curvature of the lens. Other types of polishing tools may be employed.

### Example Method of Fabricating a Shaped Optical Element

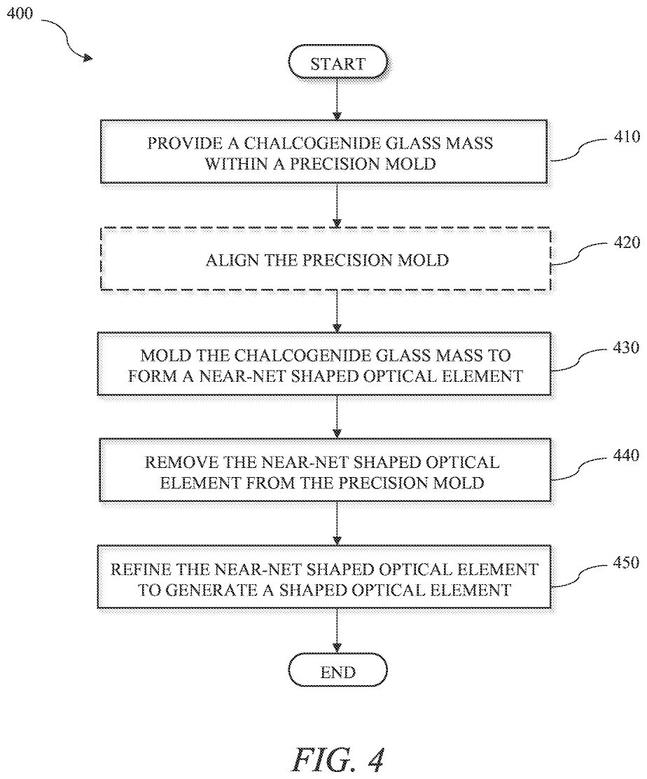

FIG. 4 illustrates an example flowchart depicting a method 400 of fabricating a shaped optical element for refracting infrared light, in accordance with example implementations. Although the method 400 is illustrated in a particular order, the steps may be performed in a different order, or omitted, altered, additional steps can be added or any combination of these are possible.

At block 410, a chalcogenide glass mass is provided within a precision mold. The chalcogenide glass mass may have a starting volume that is equal to or less than about 105% of the final volume of the shaped optical element. Alternatively, the starting volume of the chalcogenide glass mass may be equal to or less than 104%, 103%, 102%, or 101% of the shaped optical element.

Optionally, at block 420, the mold may be aligned. The mold may be aligned by using an alignment sleeve, such as but not limited to the example illustrated in FIGS. 1A-C. Other configurations are also possible. Alternatively, the mold may be aligned by adjusting a stage position and/or tilt to orient portions of the mold, such as but not limited to the example illustrated in FIGS. 2A-C.

At block 430, the chalcogenide glass mass is precision molded, by providing heat and pressure to form the chalcogenide glass mass into a near-net shaped optical element. Optionally, precision molding the chalcogenide glass mass may comprise performing the precision molding in a sealed chamber with controlled atmosphere.

At block 440, the near-net shaped optical element is removed from the precision mold.

At block 450, the near-net shaped optical element is refined to generate the shaped optical element. The near-net shaped optical element may have an outside diameter that is larger than an outside diameter of the shaped optical element by less than 25 μm. Alternatively, the near-net shaped optical element may have an outside diameter that is greater or less than 20 μm, greater or less than 15 μm, or greater or less than 10 μm, or greater or less than 5 μm, or greater or less than 4 μm, or greater or less than 2 μm, or greater or less than 1 μm of the outside diameter of the shaped optical element or may have an outside diameter in a range formed by any of these values and may include any of these values. The refining may comprise removing unwanted chalcogenide glass from the near-net shaped optical element, where the glass material removed from the near-net shaped optical element is 10% or less, 9% or less, 8% or less, 6% or less, 5% or less, 4% or less, 3% or less, 2% or less, or 1% or less of the volume of the shaped optical element or in a range formed by any of these values. The refining may comprise diamond turning the near-net shaped optical element to form the shaped optical element, such as but not limited to the finishing method using single point diamond turning illustrated in FIG. 3A. The refining may alternatively comprise grinding and/or polishing the near-net shaped optical element to form the shaped optical element, such as but not limited to the finishing method using grinding and/or polishing processes illustrated in FIG. 3B.

Although the method 400 is illustrated in a particular order, the steps may be performed in a different order, or omitted, altered, additional steps can be added or any combination of these are possible. Other process flows are possible.

As used herein, the terms “finished” or “final” product, optic, optical element, shaped optic, shaped optical element, shaped optical product, lens and “finished” or “final” shape, volume, dimensions, or properties, do not necessarily imply that there is no additional step after refining. For example, an anti-reflective coating, or coating which blocks certain wavebands, coating for electrical conductivity for EMI, or coating for durability or scratch protection can be added afterwards, as well as mounting the lens into an assembly, which may contain other optics, applying an aperture, etc.

A variety of example systems and methods are provided below.

### EXAMPLES

Example 1: A method of fabricating a shaped optical element for refracting infrared light, the method comprising:

providing a chalcogenide glass mass within a precision mold, the chalcogenide glass mass having a starting volume that is equal to or less than about 105% of the volume of the shaped optical element;

precision molding the chalcogenide glass mass by providing heat and pressure to form the chalcogenide glass mass into a near net shaped optical element;

removing the near net shaped optical element from the precision mold; and

refining the near net shaped optical element to generate the shaped optical element.

Example 2: The method of Example 1, wherein said refining the near net shaped element comprises diamond turning the near net shaped optical element to form the shaped optical element.

Example 3: The method of Example 1, wherein said refining the near net shaped element comprises grinding and/or polishing the near net shaped optical element to form the shaped optical element.

Example 4: The method of any of Examples 1-3, wherein said refining the near net shaped element comprises removing unwanted chalcogenide glass from the near net shaped optical element, wherein the glass material removed from the near net shaped optical element is no more than 3% of the volume of the shaped optical element.

Example 5: The method of any of Examples 1-3, wherein said refining the near net shaped element comprises removing unwanted chalcogenide glass from the near net shaped optical element, wherein the glass material removed from the near net shaped optical element is no more than 2% of the volume of the shaped optical element.

Example 6: The method of any of Examples 1-3, wherein said refining the near net shaped element comprises removing unwanted chalcogenide glass from the near net shaped optical element, wherein the glass material removed from the near net shaped optical element is no more than 1% of the volume of the shaped optical element.

Example 7: The method of any of Examples 1-6, wherein the starting volume of the chalcogenide glass mass is equal to or less than 103% of the shaped optical element.

Example 8: The method of any of Examples 1-6, wherein the starting volume of the chalcogenide glass mass is equal to or less than 102% of the shaped optical element.

Example 9: The method of any of Examples 1-6, wherein the starting volume of the chalcogenide glass mass is equal to or less than 101% of the shaped optical element.

Example 10: The method of any of Examples 1-9, wherein said precision molding the chalcogenide glass mass comprises performing the precision molding in a sealed chamber with controlled atmosphere.

Example 11: The method of Example 10, wherein the atmosphere is controlled to be an inert gas, air, or in vacuum.

Example 12: The method of Example 11, wherein the inert gas comprises nitrogen or argon.

Example 13: The method of any of Examples 1-12, wherein the chalcogenide glass mass has a geometry of a ball, disc, gob, rod, or rectangular solid.

Example 14: The method of any of Examples 1-13, further comprising aligning the mold using an alignment sleeve.

Example 15: The method of any of Examples 1-13, further comprising aligning the mold by adjusting a stage position and a tilt to align portions of the mold.

Example 16: The method of any of Examples 1-15, further comprising coating the shaped optical element with a lens coating.

Example 17: The method of any of Examples 1-15, further comprising coating the shaped optical element with an anti-reflective coating.

Example 18: The method of any of Examples 1-17, wherein the near-net shaped optical element has an outside diameter that is larger than an outside diameter of the shaped optical element by 25 μm or less.

Example 19: The method of any of Examples 1-17, wherein the near net shaped optical element has an outside diameter that is within 30 μm of the outer diameter of the shaped optical element.

Example 20: The method of any of Examples 1-17, wherein the near net shaped optical element has an outside diameter that is equal to the outer diameter of the shaped optical element.

Example 21: The method of any of Examples 1-17, wherein the near net shaped optical element has an outside diameter that is within 0.5 μm of the outer diameter of the shaped optical element.

Example 22: The method of any of Examples 1-17, wherein the near net shaped optical element removed from the precision mold has an outside diameter that is no more than 20 μm greater than the outside diameter of the shaped optical element.

Example 23: The method of any of Examples 1-17, wherein the near net shaped optical element removed from the precision mold has an outside diameter that is no more than 15 μm greater than the outside diameter of the shaped optical element.

Example 24: The method of any of Examples 1-17, wherein the near net shaped optical element has an outside diameter that is no more than 10 μm greater than the outside diameter of the shaped optical element.

### Other Considerations

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

Additionally, the various processes, blocks, states, steps, or functionalities may be combined, rearranged, added to, deleted from, modified, or otherwise changed from the illustrative examples provided herein. The methods and processes described herein are also not limited to any particular sequence, and the blocks, steps, or states relating thereto may be performed in other sequences that are appropriate, for example, in serial, in parallel, or in some other manner. Tasks or events may be added to or removed from the disclosed example embodiments. Moreover, the separation of various system components in the embodiments described herein is for illustrative purposes and should not be understood as requiring such separation in all embodiments.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein.

What is claimed is:

1. A method of fabricating a shaped optical element for refracting infrared light, the method comprising:
providing a chalcogenide glass mass within a precision mold, the chalcogenide glass mass having a starting volume that is equal to or less than about 105% of the volume of the shaped optical element;
precision molding the chalcogenide glass mass by providing heat and pressure to form the chalcogenide glass mass into a near-net shaped optical element;
removing the near-net shaped optical element from the precision mold; and
refining the near-net shaped optical element to generate the shaped optical element.

2. The method of claim 1, wherein said refining the near-net shaped element comprises diamond turning the near-net shaped optical element to form the shaped optical element.

3. The method of claim 1, wherein said refining the near-net shaped element comprises grinding and/or polishing the near-net shaped optical element to form the shaped optical element.

4. The method of claim 1, wherein said refining the near-net shaped element comprises removing unwanted chalcogenide glass from the near-net shaped optical element, wherein the glass material removed from the near-net shaped optical element is no more than 3% of the volume of the shaped optical element.

5. The method of claim 1, wherein said refining the near-net shaped element comprises removing unwanted chalcogenide glass from the near-net shaped optical element, wherein the glass material removed from the near-net shaped optical element is no more than 2% of the volume of the shaped optical element.

6. The method of claim 1, wherein said refining the near-net shaped element comprises removing unwanted chalcogenide glass from the near-net shaped optical element, wherein the glass material removed from the near-net shaped optical element is no more than 1% of the volume of the shaped optical element.

7. The method of claim 1, wherein the starting volume of the chalcogenide glass mass is equal to or less than 103% of the shaped optical element.

8. The method of claim 1, wherein the starting volume of the chalcogenide glass mass is equal to or less than 102% of the shaped optical element.

9. The method of claim 1, wherein the starting volume of the chalcogenide glass mass is equal to or less than 101% of the shaped optical element.

10. The method of claim 1, wherein the near-net shaped optical element removed from the precision mold has an outside diameter that is no more than 20 μm greater than the outside diameter of the shaped optical element.

11. The method of claim 1, wherein the near-net shaped optical element removed from the precision mold has an outside diameter that is no more than 15 μm greater than the outside diameter of the shaped optical element.

12. The method of claim 1, wherein the near-net shaped optical element has an outside diameter that is no more than 10 μm greater than the outside diameter of the shaped optical element.

13. The method of claim 1, wherein said precision molding the chalcogenide glass mass comprises performing the precision molding in a sealed chamber with controlled atmosphere.

14. The method of claim 13, wherein the atmosphere is controlled to be an inert gas, air, or in vacuum.

15. The method of claim 14, wherein the inert gas comprises nitrogen or argon.

16. The method of claim 1, wherein the chalcogenide glass mass has a geometry of a ball, disc, gob, rod, or rectangular solid.

17. The method of claim 1, further comprising aligning the mold using an alignment sleeve.

18. The method of claim 1, further comprising aligning the mold by adjusting a stage position and a tilt to align portions of the mold.

19. The method of claim 1, further comprising coating the shaped optical element with a lens coating.

20. The method of claim 1, further comprising coating the shaped optical element with an anti-reflective coating.

21. The method of claim 1, wherein the near-net shaped optical element has an outside diameter that is larger than an outside diameter of the shaped optical element by 25 μm or less.

22. The method of claim 1, wherein the near-net shaped optical element has an outside diameter that is within 30 μm of the outer diameter of the shaped optical element.

23. The method of claim 22, wherein the near-net shaped optical element has an outside diameter that is equal to the outer diameter of the shaped optical element.

24. The method of claim 1, wherein the near-net shaped optical element has an outside diameter that is within 0.5 μm of the outer diameter of the shaped optical element.
